(19) United States
(12) Patent Application Publication
(10) Pub. No.: US 2019/0039391 A1
(43) Pub. Date: Feb. 7, 2019

(54) METHOD OF DETECTING FEEDING STATUS AND PAPER WIDTH

(71) Applicant: Foxlink Image Technology Co., Ltd., New Taipei City (TW)

(72) Inventor: Wei Xiang Tsai, New Taipei City (TW)

(21) Appl. No.: 16/051,533

(22) Filed: Aug. 1, 2018

(30) Foreign Application Priority Data
Aug. 3, 2017 (TW) 106126288

(51) Int. Cl. B41J 11/00; B41J 13/00

(52) U.S. Cl. CPC B41J 11/003; B41J 13/0054; B41J 11/0095

(57) ABSTRACT

A method of detecting feeding status and width of paper is disclosed in this present invention, steps of the method include: step a, using at least one infrared light transmitter to transmit infrared light signals; step b, using a light-gathering element to gather together the infrared light signals transmitted by the infrared light transmitter; step c, using a light receiver to receive the infrared light signals gathered together by the light-gathering element, when paper is fed forward, the paper will be located between the infrared light transmitter and the light-gathering element, and will cover a part of the light-gathering element so as to cut off a part of the infrared light signals, how many infrared light signals the light receiver received will be changed, a feeding status and a width of the paper is determined according to how many infrared light signals the light receiver received.

### BACKGROUND OF THE INVENTION

### 1. Field of the Invention

This invention relates to a detecting method, particularly a method for detecting feeding status and width of papers.

### 2. The Related Art

Now reference to FIGS. 1, 4 and 5, the feeding path of an ordinary business machine such as a scanner is generally assembled with plural infrared emitters 100′ and infrared receivers 200′, and each infrared receiver 200′ is coupled with an infrared emitter 100′ to receive the emitted infrared signal. When the paper 300′ is fed forward in said feeding path, the paper 300′ would fully or partially blocks the infrared emitter 100′, so the infrared receiver 200′ can't receive the infrared signal sent by the infrared emitter 100′. Thus, width and skew of the document to be scanned can be detected by measuring the quantity and location of the blocked infrared emitters. Alternatively, paper jam can also be detected by comparing the quantity of blocked infrared emitters and the stetted feeding speed. (The document to be scanned 300′ can be consider as jammed if the quantity of blocked infrared emitters doesn't increase as predicted in the time period of feeding.)

Reference is now made to FIGS. 1 and 2, the optical axis of a conventional infrared emitter 100′ is aligned with the optical axis of the infrared receiver 200′. So that, the system of scanner can detect the front end of the document to be scanned 300′ is approaching the optical axis and executes related actions when the document to be scanned 300′ blocks out the infrared signal emitted by the infrared emitter 100′. the detection of said blocking out of infrared signal is judged by the change of the voltage of the infrared receiver 200′ (the infrared receiver 200′ changes received infrared signal into electric signals). The complete detecting process is shown below: measuring the receiver voltage (N) when there is no paper between the infrared emitter 100′ and the infrared receiver 200′; then measuring the receiver voltage (M) when the infrared signal is blocked out. So that, the receiver voltage when the paper to be scanned is just about to block out the infrared signal would be (N+M)/2 and therefore when the receiver voltage is (N+M)/2, the documents 300′ to be scanned is blocking out the infrared signal emitted by the infrared emitter 100′ and which means the front end of documents to be scanned is approaching the optical axis of the infrared emitter 100′ and the infrared receiver 200′.

Referring to FIG. 3 now, the optical axis of the infrared emitter 100′ and the optical axis of the infrared receiver 200′ doesn't always align correctly. If the bias between both optical axis is larger than a threshold, that the receiver voltage would be lower than (N+M)/2 before the documents to be scanned completely blocks the optical axis of the infrared emitter 100′ or the optical axis of the infrared receiver 200′, which means the front end of documents to be scanned is not yet approaching the optical axis of the infrared emitter 100′ or the optical axis of the infrared receiver 200′. The worse is receiver voltage is lower than (N+M)/2 even when there is no document between the infrared emitter 100′ and the infrared receiver 200′, in that case the system will always misjudge the feeding status.

Therefor, it is necessary to provide a method to detect feeding status and width of the document to be scanned which requires fewer infrared emitters and receivers so as to make the production cost of the scanner lower and improve the effect of paper detect.

### SUMMARY OF THE INVENTION

The objective of the present invention is to provide a feeding status and document width detecting method for overcoming the defects in the prior art. The quantity of infrared emitters and infrared receivers can be reduced by using the method, and further reducing the implementation cost and improving the effect of detection.

To achieve said objective, the present invention provides a method for detecting feeding status and documents width which comprises the following steps: a. emitting an infrared signal with an infrared emitter; b. gathering said infrared signal emitted by the infrared emitter with a light combiner; c. receiving the infrared signal gathered by said light combiner with an infrared receiver, wherein when the documents being fed through the infrared emitter and the infrared receiver, it would shade part of the light combiner so as to block out part of infrared signal, so the feeding status and the width of the document can be determined by measuring intensity of infrared signal received by the infrared receiver.

In conclusion, the detecting method in this invention detects feeding status and paper width by measuring the area of light combiner being shaded by the document 50, and said shaded area is measured by measuring the intensity of infrared signal received by the infrared receiver 40, and said intensity of infrared signal is measured by measuring the receiver voltage. Therefore, the detecting method in this invention can also detects paper jam, paper skew and the paper width and requires less infrared emitter 10 and infrared receiver 40 in compared with the prior art, thus reduce the production cost and enhance the detecting effect.

### BRIEF DESCRIPTION OF THE DRAWINGS

The present invention will be apparent to those skilled in the art by reading the following description, with reference to the attached drawings, in which:

FIG. 1 is a schematic diagram showing an infrared emitter and an infrared receiver of prior art;

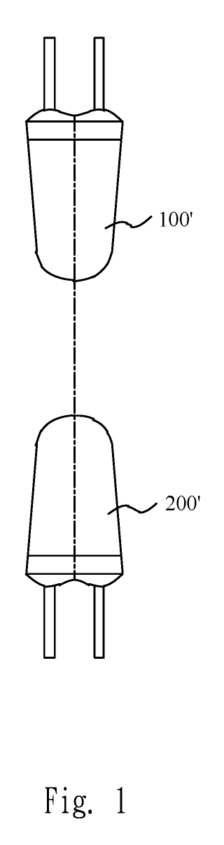

FIG. 2 is a schematic diagram showing a document to be scanned approaching the optical axis of the infrared emitter of the prior art;

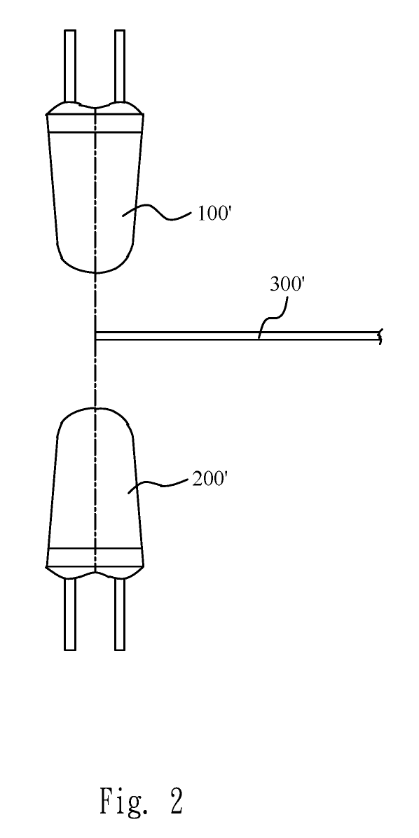

FIG. 3 is a schematic diagram showing the infrared emitter and the infrared receiver doesn't align correctly;

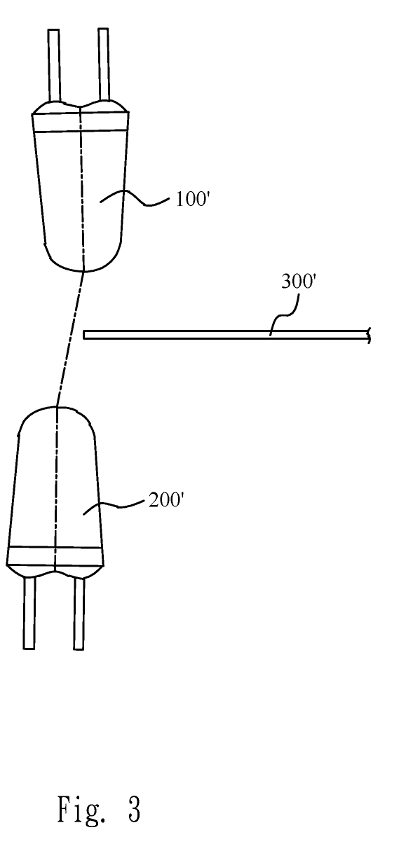

FIG. 4 is a schematic diagram showing the detecting process of paper width of the prior art;

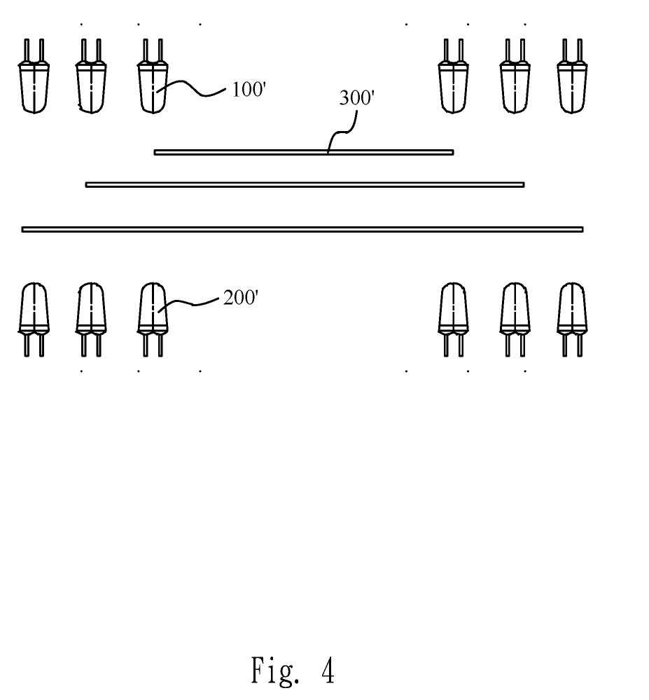

FIG. 5 is a schematic diagram showing the detecting process of paper jam of the prior art;

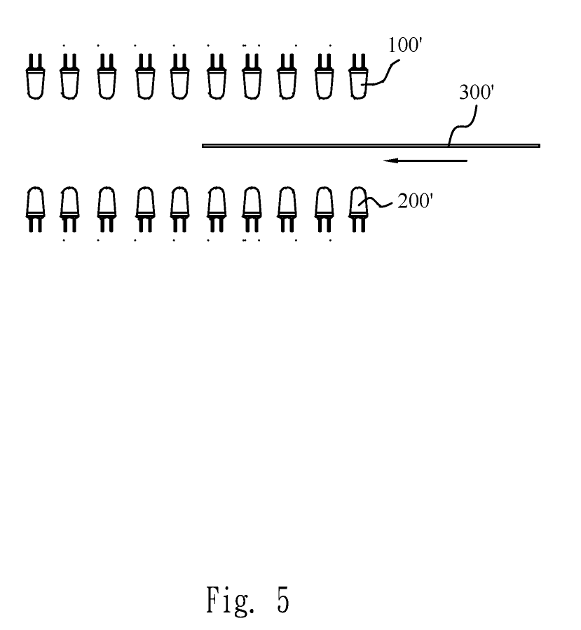

FIG. 6 shows a flowchart of detecting method of the feeding status and paper width according to an embodiment of this invention;

FIG. 7 shows a perspective view of the infrared emitter, infrared receiver, light splitter and light combiner used in the method of detecting feeding status and paper width according to an embodiment of this invention;

FIG. 8 shows a left-side view of the light splitter and the light combiner used in the method of detecting feeding status and paper width in according to an embodiment of this invention;

FIG. 9 is a schematic diagram showing the detecting process for detecting feeding status and paper width according to an embodiment of this invention;

FIG. 10 is a schematic diagram showing the detecting process for detecting paper skew according to an embodiment of this invention;

FIG. 11 is a schematic diagram showing the detecting process for detecting paper width according to an embodiment of this invention;

FIG. 12 is a schematic diagram showing the detecting process for detecting feeding status with a light splitter and a light combiner in according to another embodiment of this invention;

FIG. 13 is a schematic diagram showing the linear regression process of the test data shown in table 1 and table 2 in according to an embodiment of this invention;

FIG. 14 shows a flowchart of the detecting method of detecting feeding status and paper width in according to another embodiment of this invention; and

FIG. 15 shows a left-side view of the light splitter and the light combiner used in the method of detecting feeding status and paper width in according to another embodiment of this invention.

### DETAILED DESCRIPTION OF THE PREFERRED EMBODIMENT

In order to describe the technical contents, structural features, purpose to be achieved and the effectiveness of the present invention, the detailed description is given with schema below.

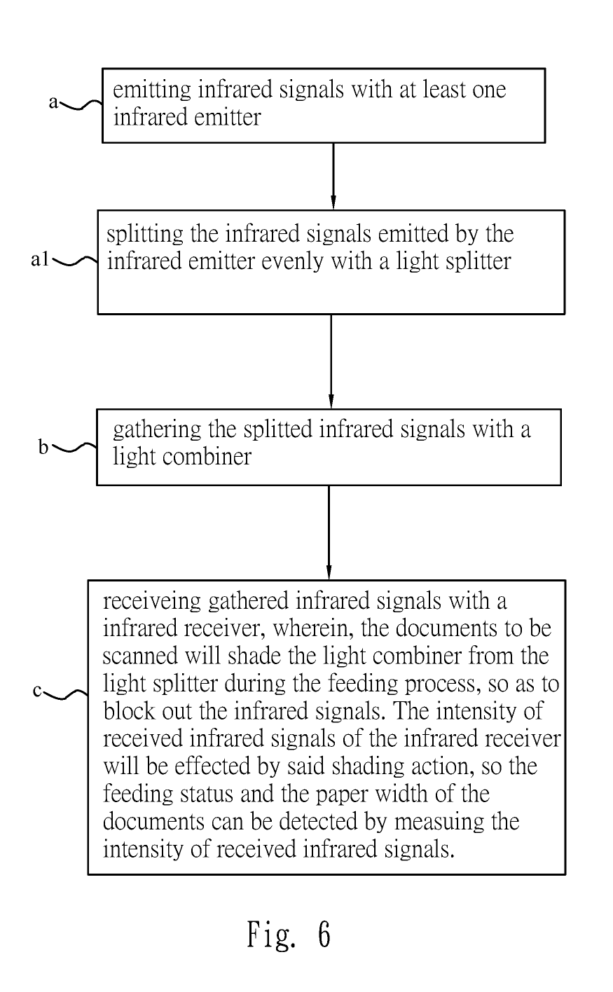

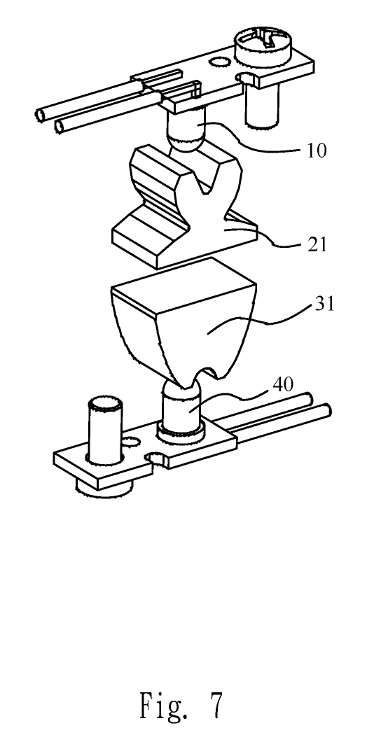

Referring to FIG. 6 and FIG. 7, the feeding status and paper width detecting method in this invention comprises the following steps: a. emitting infrared signals with at least one infrared emitter 10,

a1. splitting the infrared signals emitted by the infrared emitter 10 evenly with a light splitter;

b. gathering the split infrared signals with a light combiner;

c. receiving gathered infrared signals with an infrared receiver 40, wherein, the documents to be scanned 50 will shade the light combiner from the light splitter during the feeding process, so as to block out the infrared signals. The intensity of received infrared signals of the infrared receiver 40 will be affected by said shading action, so the feeding status and the paper width of the documents 50 can be detected by measuring the intensity of received infrared signals.

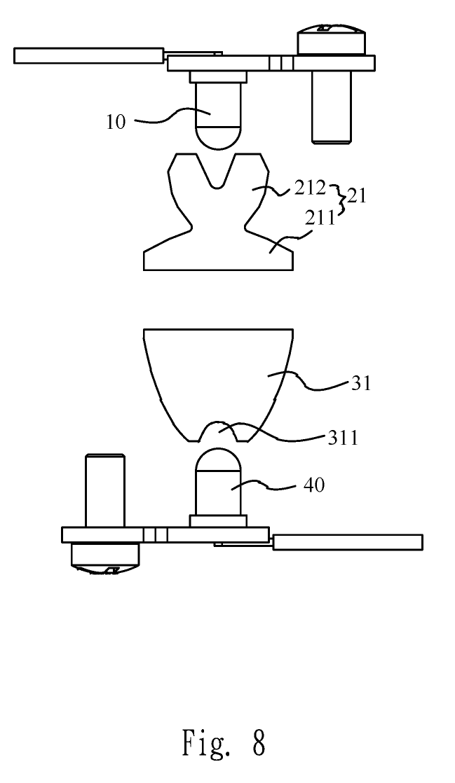

FIG. 7 and FIG. 8 that schematically illustrates a preferred embodiment of the light splitter 21 and the light combiner 31 used in this invention. The light splitter 21 shown in this embodiment is made of transparent material and comprising a root section 211 and a light-guiding section 212, said light-guiding section 212 being arranged next to the infrared emitter 10 and comprising a V-shape concave, and said root section 211 being arranged on the opposite end of the light-guiding section 212 and the surface which faces the infrared emitter 10 being formed in an arc-shape. The light combiner 31 is made of transparent material and comprising a small end which being arranged next to the infrared receiver 40 and a large end which being arranged on the opposite end of the small end, the adjacent surfaces of the large and small ends being formed as flat plane and the surface of the small end that being faced to the infrared receiver comprising a curved concave 311.

Referring to FIG. 7 to FIG. 10 and the table 1 and table 2 now, table 1 and table 2 are the testing data of the light splitter 21 and the light combiner 31. The irradiation angle of the infrared emitter 10 in this invention is 50 degrees. The resistance is 45.4 kΩ. The surface of the root section 211 and the surface of the large end are rectangular flat plane, the length of said rectangular surface are 10 mm and the width of said rectangular surface are 6.1 mm. The longer edge of said rectangular surface is parallel with the feeding direction of documents to be scanned, which means documents 50 is fed in the direction of the extended direction of the longer edge of the light splitter 21. The infrared signals emitted by the infrared emitter 10 being split evenly along the extending direction of the longer edge of the rectangular surface and irradiates the light combiner 31. The adjoined surface of the light combiner 31 to the light splitter 21 is also a 10 mm*6.1 mm rectangular flat surface. The side surfaces of the light combiner 31 which are contacts with the longer edges of the rectangular surface are also formed as flat surface, and the side surfaces which contacts with the short edges are curved surface. As shown in table 1 and table 2, the detecting area of the light combiner in this invention is 9 mm in length (5 mm width surrounding the edge is non-detecting zone), and when the document 50 being fed to the position that shades half of the light combiner the receiver voltage of the infrared receiver is 1.6 V.

Referring to FIGS. 7 to 10 now, it needs at least two sets of infrared emitters and infrared receivers which arranged at the right and left side respectively for detecting the paper skew in this invention. A light splitter and a light combiner are arranged between each set of the infrared emitter and the infrared receiver. The distance between said infrared emitters is 100 mm, and the receiver voltage of each infrared receivers 40 would be different when paper skew happens. The angle of the document can be calculated through the following steps: change the received infrared signal into electric voltages with said infrared receivers, and measure the position of the front end of the document 50 (the position of the left-side front end being set as X1, and the position of right-side front end being set as X2), so that the distance difference between the left and right sides of document would be X (X=X1−X2). It is known that the distance (L) between both infrared receivers is 100 mm, so the skewing angle (θ) of the document can be calculated through equation (Arctan(X/L)=θ) and so as to determine whether the document 50 is skewed and the skewing angle of the document 50. Generally speaking, the threshold of skewing angle would be set at 5 degrees, the scanner will stop feeding when the skewing angle is larger than 5 degrees, and it would be considered as normal status when the skewing angle is lesser than 5 degrees. In result, the method in the present invention can significantly reduce the quantity of the infrared emitters and receivers and enhance the detecting effect in compare with prior art.

Referring to FIG. 7, 9 and the table 1 and 2 now, it only takes one infrared emitter 10 and one infrared receiver 40 to detect paper jam in this invention. Between the infrared emitter 10 and the infrared receiver 40 is also arranged with a light splitter and a light combiner. During the feeding process, the document to be scanned 50 would shade the light combiner so as to affect the intensity of received infrared signal and the receiver voltage. The receiver voltage will reduce with the feeding process, if not, it can be considered that the document is jammed. The light splitter 31 and the light combiner 21 in this embodiment are formed in quasi-rectangular shape and its longer edge is parallel to the feeding direction. In normal feeding status, every 0.5 mm the document being fed forward, the receiver voltage would reduce 0.15 V in average. Therefore, if the receiver voltage reduced less than 0.15 V and the feeding time is long enough to feed the document for 2 mm, the document is considered as jammed.

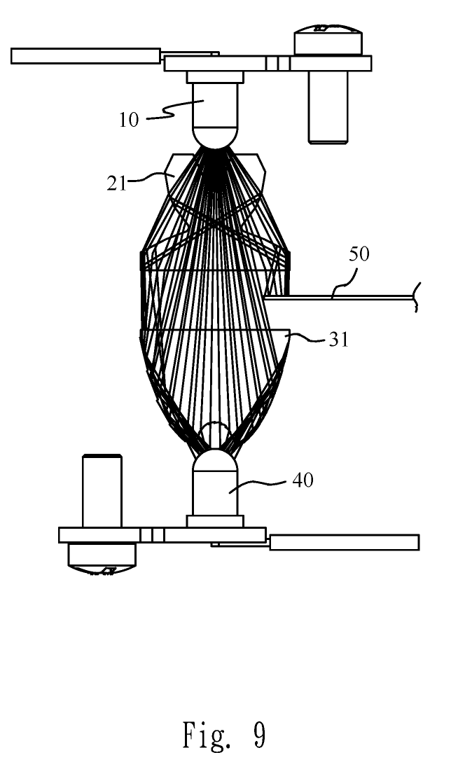

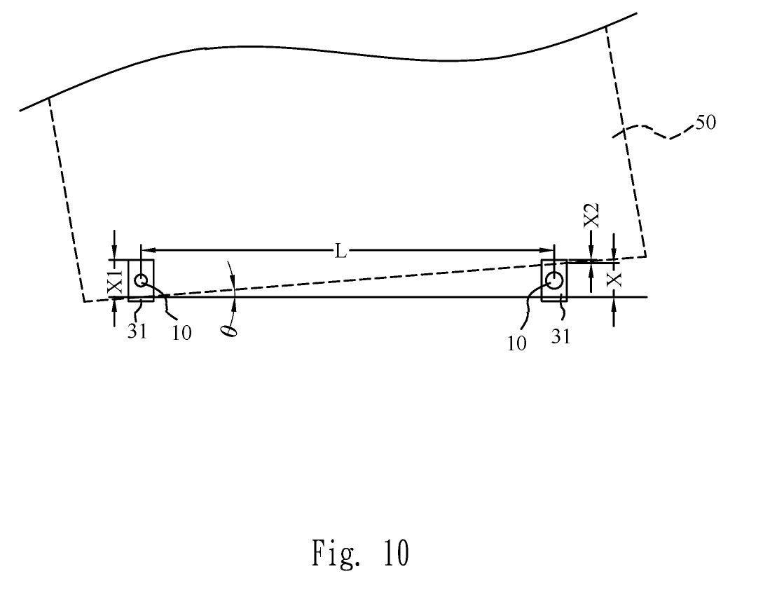

Referring to FIGS. 9 and 10 now, it only takes two sets of infrared emitters 10 and receivers 40 to detect the width of the document. Said 2 sets of emitters 10 and receivers 40 are arranged at the right and left side of the feeding path respectively, and the distance therebetween is set as D, a set of light splitters 31 and light combiner 21 is also arranged between each sets of emitters 10 and receivers 20. The light splitter 31 and the light combiner 21 in this embodiment are formed in quasi-rectangular shape and its longer edge is perpendicular to the feeding direction, so as to detect a wider range.

When the document to be scanned 50 being fed forward, the right end and the left end of the document 50 would be positioned between two sets of light splitters 31 and light combiners 21 mentioned above respectively, the document 50 might shade different number of light combiners 21 so the infrared receivers 40 at the right and left side of the feeding path might receive different intensity of infrared signal. The shaded distance (A1 as the shading distance of the left side light combiner and A2 as the right-side light combiner) of both light combiners can be determined by measuring the receiver voltage of both infrared receivers. The distance between two infrared receiver 40 being set as D, so the paper width P would be P=D+A1+A2. The paper width detecting method disclosed in this invention detects the paper width by measuring the receiver voltage, so that it only needs two sets of infrared emitters 10 and infrared receivers 40 and has a better detecting effect in compared with the prior art.

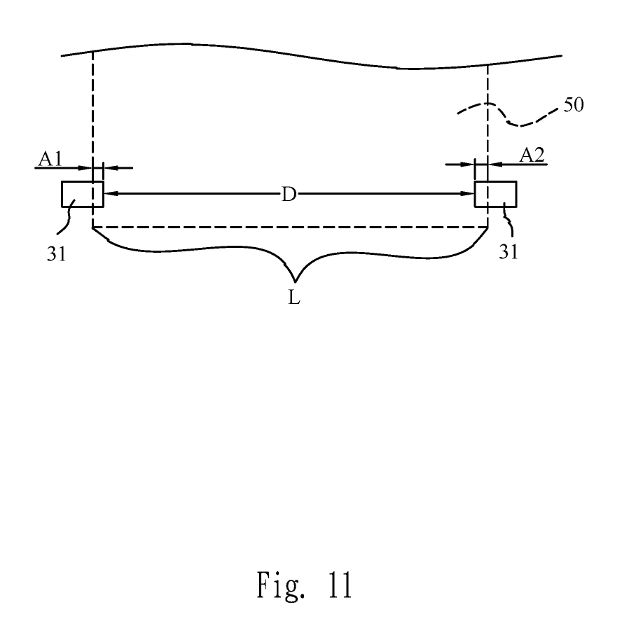

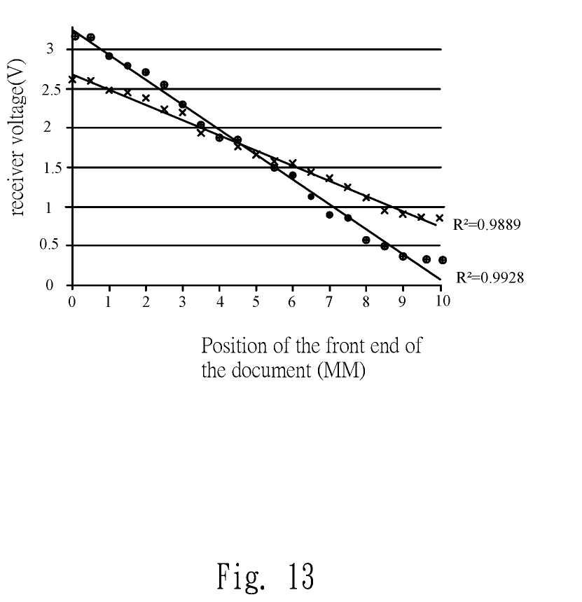

Referring to FIGS. 8 to 13 now, two different thickness of documents being fed in this embodiment (280 gsm and 350 gsm). According to the testing result, the receiver voltage is highly related to the shading distance of the light combiner 31 regardless the paper thickness. And the paper skew, paper jam and the paper width can all be detected correctly.

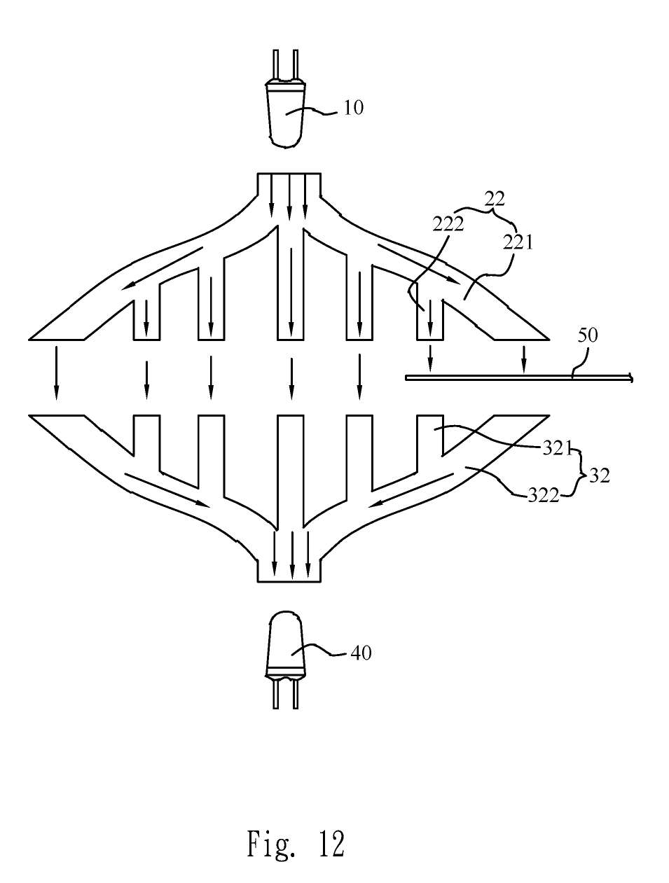

Referring to FIG. 12 now, another preferred embodiment of the light splitter 22 and light combiner 32 are shown. The light splitter 22 in this embodiment is made of a transparent material and comprising a plural of main-branch of light splitter 221, each of main-branch of light splitter 221 is separated with each other in V shape and extended toward the light combiner 32, the cross-section of said main-branch of light splitter is in circle shape and a plural of sub-branch of light splitter 222 are extended from said main-branch of light splitter 221 toward the infrared receiver 40. The light combiner 32 in this embodiment is also made of transparent material and comprising a plural of main-branch of light combiner 321, each of main-branch of light combiner 321 is separated with each other in V shape and extended toward the infrared emitter 10 and plural of sub-branch of light combiner 322 are extended from the main-branch of light combiner 321 in corresponded to the sub-branch of light splitter 222, said sub-branch of light combiner 322 being extended toward the infrared emitter 10. When the infrared emitter 10 in this embodiment being activated, the infrared signal will be guided into each main-branch of light splitter 221 and sub-branch of light splitter 222 and split into plural of infrared beams evenly, said infrared beams irradiated the light combiner 32 and being guiding through the sub-branch of light combiner 322 and the main-branch of light combiner 321 so as to united into a single infrared beam. The document 50 would shade parts of the sub-branch of light combiner 322 and hence blocks out the infrared beam, so that the intensity of received infrared and the receiver voltage would reduce in result, therefore, the feeding status, paper skew, paper jam and the paper width can be detected by measuring the receiver voltage.

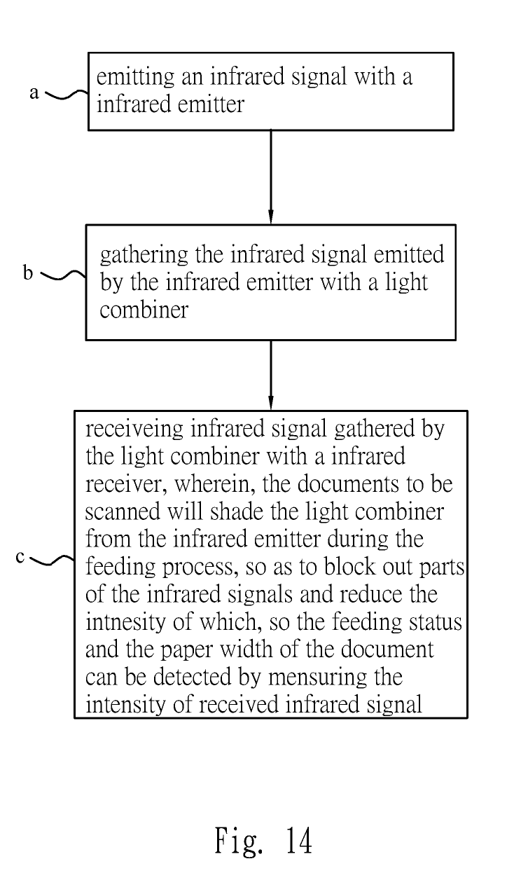

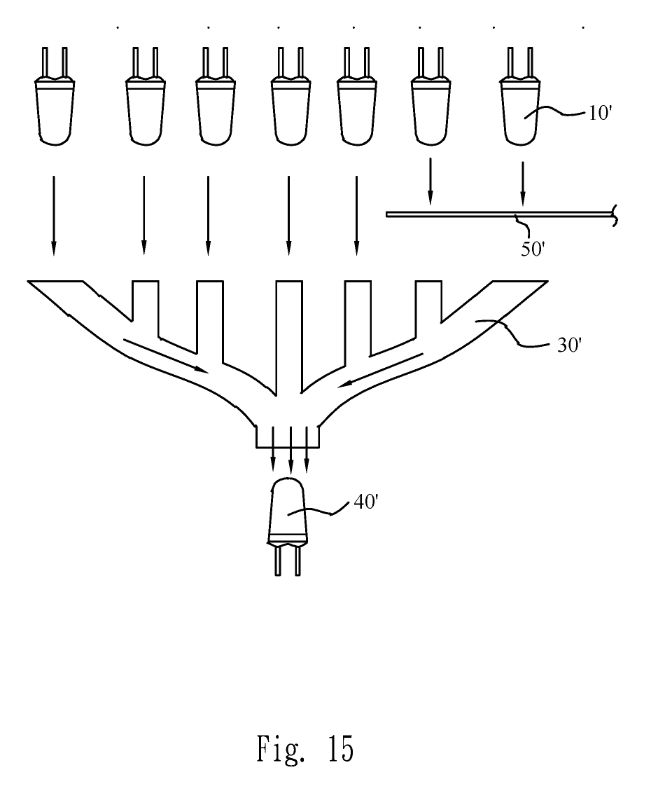

Referring to FIGS. 14 and 15 now, another preferred detecting method is shown in this embodiment, said method comprising the following steps:

a. emitting an infrared signal with an infrared emitter 10;

b. gathering the infrared signal emitted by the infrared emitter 10′ with a light combiner 30′;

c. receiving infrared signal gathered by the light combiner 30′ with an infrared receiver 40′, wherein, the documents to be scanned 50 will shade the light combiner 30′ from the infrared emitter 10′ during the feeding process, so as to block out parts of the infrared signals and reduce the intensity of which, so the feeding status and the paper width of the document 50′ can be detected by measuring the intensity of received infrared signal.

Referring to FIGS. 14 and 15 now, when the document 50′ being fed forward, the document 50′ would blocks out part of the infrared signal emitted by the infrared emitter 10′, so as to cause the infrared receiver 40′ receiving less infrared signal, and the lesser received infrared signal changes into lower receiver voltage. Therefore, the detecting method in this invention can detects feeding status, paper skew, paper jam and paper width of the document to be scanned 50′ with only one light receiver 40′, hence to reduce the production cost of the scanner and enhance the detecting affection.

In conclusion, the detecting method in this invention detects feeding status and paper width by measuring the area of light combiner being shaded by the document 50, and said shaded area is measured by measuring the intensity of infrared signal received by the infrared receiver 40, and said intensity of infrared signal is measured by measuring the receiver voltage. Therefore, the detecting method in this invention can also detects paper jam, paper skew and the paper width and requires less infrared emitter 10 and infrared receiver 40 in compared with the prior art, thus reduce the production cost and enhance the detecting effect.

What is claimed is:

1. A method for detecting feeding status and paper width, including:
a. emitting an infrared signal with at least one infrared emitter;
b. capturing and focusing said infrared signal emitted by said infrared emitter with a light combiner;
c. receiving the infrared signal focused by the light combiner with a light receiver;
wherein, the document would shading parts of light combiner and so as to block out parts of the infrared signal emitted by the infrared emitter, and thus reducing the intensity of the infrared signal received by the infrared receiver, so that the feeding status and the paper width being determined by measuring the intensity of the received infrared signal.

2. The method for detecting feeding status and paper width as claimed in claim 1, wherein the light combiner being made of transparent material and comprising a small end which being arranged next to the infrared receiver and a large end which being arranged on the opposite end of the small end, the adjacent surfaces of the large and small ends being formed as flat plane and the surface of the small end that being faced to the infrared receiver comprising an curved concave.

3. The method for detecting feeding status and paper width as claimed in claim 1, wherein the light combiner being made of transparent material and comprising a plural of main-branch of light combiner, each of main-branch of light combiner being separated with each other in V shape and extended toward the infrared emitter, and plural of sub-branch of light combiner are extended from the main-branch of light combiner, said sub-branch of light combiner being extended toward the infrared emitter and having a circle shape cross-section.

4. The method for detecting feeding status and paper width as claimed in claim 1, wherein said step a. further comprising the following steps: a1. splitting the infrared signals emitted by the infrared emitter evenly with a light splitter, the light combiner capturing and focusing the infrared signal split by the light splitter, and the document being fed between the light splitter and the light combiner during the feeding process.

5. The method for detecting feeding status and paper width as claimed in claim 4, wherein the light splitter being made of transparent material and comprising a root section and a light guiding section, the light guiding section being formed in a V-shape and its opening being disposed to face the light emitter, the side-surface of the root section which being faced the infrared emitter being formed in a curved shape and the light guiding section being connected to the root section in the middle of the curved side surface.

6. The method for detecting feeding status and paper width as claimed in claim 4, wherein the light splitter being made of transparent material and comprising a main-branch of light splitter which being formed in V-shape and the opening of which arranged to face the light combiner, the cross section of the main-branch of light splitter being formed in circle shape, and a plural of sub-branch of light splitter being disposed on the main-branch of light splitter separately, the cross section of the sub-branch of light splitter being formed in a circle shape and said sub-branch light splitter being extended toward the infrared receiver.
